(19) United States
(12) Patent Application Publication
(10) Pub. No.: US 2020/0116868 A1
(43) Pub. Date: Apr. 16, 2020

(54) SATELLITE SIGNAL PROCESSING APPARATUS AND UNMANNED AERIAL VEHICLE

(71) Applicant: SZ DJI TECHNOLOGY CO., LTD., Shenzhen (CN)

(72) Inventors: Jianhua ZHANG, Shenzhen (CN); Bin HAN, Shenzhen (CN); Xiaoying QIU, Shenzhen (CN); Yue DONG, Shenzhen (CN)

(21) Appl. No.: 16/713,572

(22) Filed: Dec. 13, 2019

Related U.S. Application Data
(63) Continuation of application No. PCT/CN2017/091243, filed on Jun. 30, 2017.

(51) Int. Cl. G01S 19/30; G01S 19/37

(52) U.S. Cl. CPC G01S 19/30; G01S 19/37

(57) ABSTRACT

A satellite signal processing apparatus includes a digital frontend circuit configured to process a radio frequency signal received from an antenna to obtain a baseband signal, a buffer configured to buffer the baseband signal obtained from the digital frontend circuit, a pseudo-code broadcast circuit storing pseudo-codes of a plurality of satellites, and a baseband signal processing channel coupled to the pseudo-code broadcast circuit and configured to perform a work task based on a pseudo-code broadcasted by the pseudo-code broadcast circuit and the baseband signal obtained from the buffer.

### CROSS REFERENCE TO RELATED APPLICATION

This application is a continuation of International Application No. PCT/CN2017/091243, filed on Jun. 30, 2017, the entire content of which is incorporated herein by reference.

### TECHNICAL FIELD

The present disclosure relates to signal processing technologies and, more particularly, to a satellite signal processing apparatus and an unmanned aerial vehicle.

### BACKGROUND

Currently, satellite-based navigation systems are becoming mainstream positioning and navigation systems. At present, satellite positioning navigation systems include the Global Positioning System (GPS) of the United States, the Global Navigation Satellite System (GLONASS) of Russia, the Galileo Global Navigation Satellite System of European Union, and the BeiDou Navigation Satellite System (BDS) of China. Receivers of a global navigation satellite system (GNSS) can improve a positioning accuracy of user devices (e.g., smart terminals, automobiles, and unmanned aerial vehicles, etc.) However, the GNSS receivers need to perform substantial calculations (e.g., correlation operations) in baseband signal processing. Thus, it takes longer time to capture and track satellite signals. For example, three-dimensional search of frequency, time, and pseudo-code must be performed on GPS signals to determine parameters of the satellite signals. The GNSS receivers in the existing technology are inferior in terms of substantial system storage resource consumption, long positioning time, and inefficient signal processing.

### SUMMARY

In accordance with the disclosure, there is provided a satellite signal processing apparatus including a digital frontend circuit configured to process a radio frequency signal received from an antenna to obtain a baseband signal, a buffer configured to buffer the baseband signal obtained from the digital frontend circuit, a pseudo-code broadcast circuit storing pseudo-codes of a plurality of satellites, and a baseband signal processing channel coupled to the pseudo-code broadcast circuit and configured to perform a work task based on a pseudo-code broadcasted by the pseudo-code broadcast circuit and the baseband signal obtained from the buffer.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic diagram of a satellite signal processing apparatus according to an example embodiment.

FIG. 2 is a schematic diagram of another satellite signal processing apparatus according to an example embodiment.

FIG. 3 is a schematic diagram of another satellite signal processing apparatus according to an example embodiment.

FIG. 4 is a schematic diagram of another satellite signal processing apparatus according to an example embodiment.

FIG. 5A is a schematic diagram showing time-division task processing according to an example embodiment.

FIG. 5B is a schematic diagram showing time-division task processing according to another example embodiment.

FIG. 6 is a schematic diagram of another satellite signal processing apparatus according to an example embodiment.

FIG. 7 is a schematic diagram of another satellite signal processing apparatus according to an example embodiment.

FIG. 8 is a schematic diagram of another satellite signal processing apparatus according to an example embodiment.

FIG. 9 is a schematic diagram showing hardware-software interaction according to an example embodiment.

FIG. 10 is a schematic diagram of another satellite signal processing apparatus according to an example embodiment.

FIG. 11 is a schematic diagram of another satellite signal processing apparatus according to an example embodiment.

FIG. 12 is a schematic diagram of hardware-software interaction according to another example embodiment.

FIG. 13 is a schematic diagram of another satellite signal processing apparatus according to an example embodiment.

FIG. 14 is a schematic diagram showing hardware-software interaction according to another example embodiment.

FIG. 15 is a schematic diagram showing hardware-software interaction according to another example embodiment.

FIG. 16 is a schematic diagram showing hardware-software interaction according to another example embodiment.

FIG. 17 is a schematic diagram of another satellite signal processing apparatus according to an example embodiment.

FIG. 18 is a schematic diagram of another satellite signal processing apparatus according to an example embodiment.

FIG. 19 is a schematic diagram of an unmanned aerial vehicle according to an example embodiment.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

In some embodiments of the present disclosure, a pseudo-code broadcasting circuit is configured to store pseudo-codes of a plurality of satellites, such that each baseband signal processing channel is not needed to store the pseudo-codes of all the satellites in a navigation system, thereby reducing consumption of system storage resources.

In some embodiments of the present disclosure, each baseband signal processing channel processes multiple tasks in a time-division manner in an operation cycle to improve utilization of hardware resources and task processing efficiency.

In some embodiments of the present disclosure, two baseband signal storage spaces are configured in a buffer and baseband signals are obtained alternately from the two baseband signal storage spaces by using a ping-pong address policy to improve an efficiency of obtaining the baseband signals by the baseband signal processing channel and to improve a processing efficiency of the baseband signal processing channel and utilization of hardware resources. Two information storage spaces are configured using an external device and configuration information of work tasks is obtained alternately from the two information storage spaces by using a ping-pong address policy to improve an efficiency of obtaining the configuration information of the work tasks. Two task result storage spaces are configured using the external device and task results are written alternately to the two task result storage spaces by using a ping-pong address policy to improve an efficiency of writing the task results.

The technical aspects of the present disclosure are described below in several embodiments. It should be noted that features of the embodiments and examples described below may be combined with each other under the circumstances of non-conflicting. Descriptions about same or similar concepts or processes may not be repeated in some embodiments.

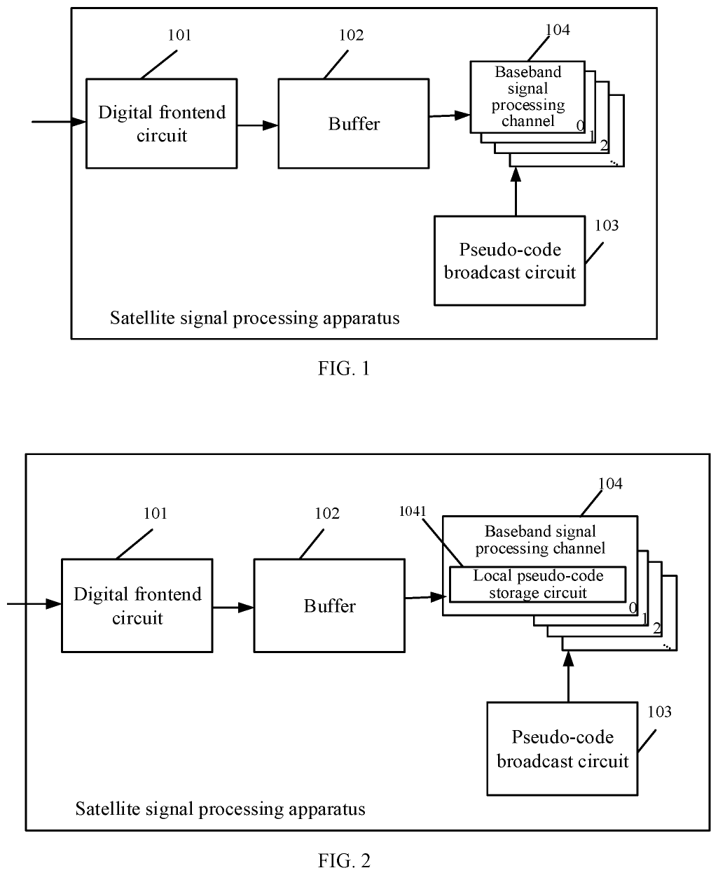

FIG. 1 is a schematic diagram of a satellite signal processing apparatus according to an example embodiment. As shown in FIG. 1, the satellite signal processing apparatus includes a digital frontend (DFE) circuit 101, a buffer 102, a pseudo-code broadcast circuit 103, and a plurality of baseband signal processing channels 104. The pseudo-code broadcast circuit 103 is connected to each of the plurality of baseband signal processing channels 104. The pseudo-code broadcast circuit 103 stores pseudo-codes of a plurality of satellites. The plurality of satellites may include all the satellites in a preset navigation system. The preset navigation system may be one or more of BeiDou, GPS, Galileo, and GLONASS systems.

The digital frontend circuit 101 processes a radio frequency signal received from an antenna to obtain a baseband signal. The buffer 102 buffers the baseband signal obtained from the digital frontend circuit 101. The pseudo-code broadcast circuit 103 transmits the pseudo-codes of the plurality of satellites to the plurality of baseband signal processing channels 104. The pseudo-codes of the plurality of satellites include a pseudo-code of a satellite that one or more of the plurality of baseband signal processing channels 104 need to perform a work task. Based on the pseudo-code transmitted from the pseudo-code broadcast circuit 103 and the baseband signal obtained from the buffer 102, a baseband signal processing channel 104 performs the work task.

In some embodiments, the work task includes a capturing task or a tracking task.

In the embodiments provided by the present disclosure, the satellite signal processing apparatus includes the digital frontend circuit, the buffer, the pseudo-code broadcast circuit, and the plurality of baseband signal processing channels. The pseudo-code broadcast circuit is respectively connected to each and every one of the plurality of baseband signal processing channels. The pseudo-code broadcast circuit stores the pseudo-codes of all the satellites in the preset navigation system. The pseudo-code broadcast circuit transmits the pseudo-codes of the plurality of satellites to the plurality of baseband signal processing channels, such that individual baseband signal processing channels no longer need to store the pseudo-codes of all the satellites in the preset navigation system, thereby reducing the consumption of the system storage resources.

In some embodiments, as shown in FIG. 1, a first baseband signal processing channel is configured to send a pseudo-code request to the pseudo-code broadcast circuit. The pseudo-code broadcast circuit is configured to broadcast a pseudo-code requested by the pseudo-code request to the plurality of baseband signal processing channels. The first baseband signal processing channel is configured to perform the capturing task or the tracking task based on the pseudo-code requested by the pseudo-code request and the digital intermediate frequency signal outputted from the buffer. For example, the first baseband signal processing channel may be any one of the plurality of baseband signal processing channels. When the first baseband signal processing channel needs a pseudo-code of a certain satellite to perform the work task, the first baseband signal processing channel may send the pseudo-code request to the pseudo-code broadcast circuit to request the pseudo-code broadcast circuit to transmit the pseudo-code requested by the pseudo-code request to the first baseband signal processing channel.

The pseudo-code request may include a satellite sequence number or other identifiers uniquely identifying the satellite. After the pseudo-code broadcast circuit receives the pseudo-code request, the pseudo-code broadcast circuit determines the pseudo-code of the corresponding satellite based on the pseudo-code request. The pseudo-code broadcast circuit broadcasts the pseudo-code of the satellite to the plurality of baseband processing channels. The first baseband signal processing channel receives the pseudo-code of the satellite broadcasted by the pseudo-code broadcast circuit and performs the work task based on the pseudo-code of the satellite and the baseband signal obtained from the buffer. The pseudo-code broadcast circuit broadcasts the pseudo-code of the satellite to the plurality of baseband signal processing channels instead of transmitting the pseudo-code of the satellite to each of the plurality of baseband signal processing channels in one-to-one communication. Thus, system power consumption may be effectively reduced.

In some embodiments, the baseband signal processing channel may send the pseudo-code request to the pseudo-code broadcast circuit every time the baseband signal processing channel performs the work task. In some embodiments, the baseband signal processing channel may send the pseudo-code request to the pseudo-code broadcast circuit when performing the current work task that needs the pseudo-code different from the pseudo-code needed for performing the preceding work task. When performing the current work task that needs the pseudo-code same as the pseudo-code needed for performing the preceding work task, the baseband signal processing channel does not send any pseudo-code request to the pseudo-code broadcast circuit. Thus, the processing efficiency of the baseband signal processing channel may be improved, and the system power consumption may be reduced.

In some embodiments, the baseband signal processing channel further includes a local pseudo-code storage circuit 1041, as shown in FIG. 2. The local pseudo-code storage circuit 1041 is configured to receive and save the pseudo-code broadcasted by the pseudo-code broadcast circuit. The baseband signal processing channel is configured to perform the work task based on the pseudo-code saved in the local pseudo-code storage circuit 1041 and the baseband signal outputted from the buffer. For example, the pseudo-code broadcast circuit broadcasts the pseudo-code of the satellite to the plurality of baseband signal processing channels. When the baseband signal processing channel needs the pseudo-code of the satellite, the local pseudo-code storage circuit 1041 of the baseband signal processing channel may save the pseudo-code of the satellite. The baseband signal processing channel performs the work task based on the pseudo-code saved in the local pseudo-code storage circuit 1041 and the baseband signal obtained from the buffer. When the baseband signal processing channel does not need the pseudo-code of the satellite, the local pseudo-code storage circuit may not save the pseudo-code of the satellite. The local pseudo-code storage circuit 1041 only saves the pseudo-code needed for performing the current work task. Thus, the storage space of the baseband signal processing channel may be saved, and the system power consumption may be reduced.

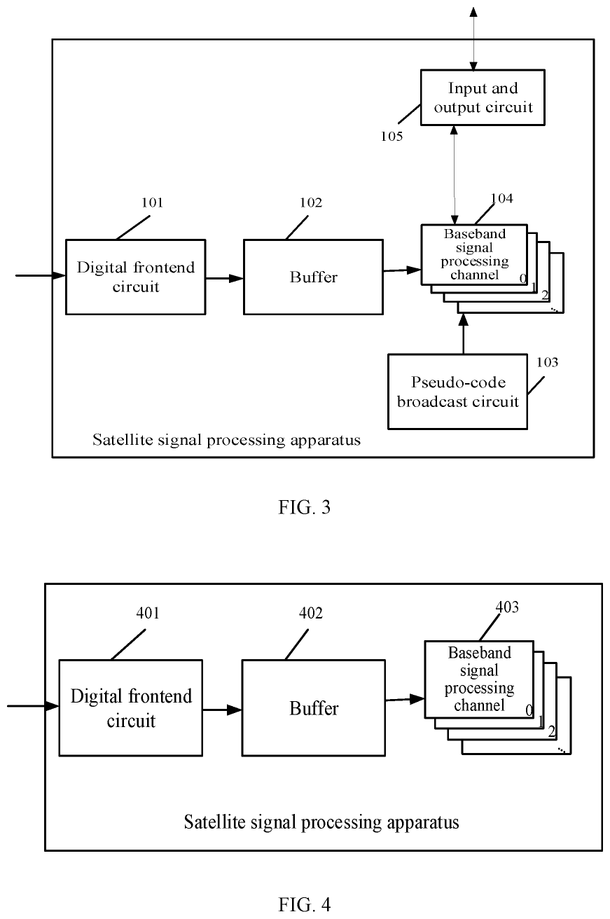

In some embodiments, the satellite signal processing apparatus further includes an input and output circuit 105, as shown in FIG. 3. The input and output circuit 105 is a communication connection device between the external device and the baseband signal processing channel, and is configured to exchange data with the external device. For example, the input output circuit 105 obtains configuration information of the work task of the baseband signal processing channel from the external device and sends the configuration information of the work task to the baseband signal processing channel. Based on the configuration information of the work task, the pseudo-code transmitted from the pseudo-code broadcast circuit, and the baseband signal obtained from the buffer, the baseband signal processing channel performs the work task. The configuration information of the work task will be described later in relevant sections of the specification and is not described herein. After the work task is performed, the baseband signal processing channel outputs a work task result corresponding to the work task. The input and output circuit 105 is also configured to obtain the work task result outputted from the baseband signal processing channel and to send the work task result to the external device. The external device may be a special-purpose or general-purpose processor, or a dual data rate (DDR) synchronous dynamic random access memory. The external device may also be other types of memories. The input and output circuit may be connected to the external device through an AXI4 protocol.

In the examples described below, a first operation cycle may be any one of operation cycles, and a second operation cycle may be any one of the operation cycles other than the first operation cycle. In some embodiments, the first operation cycle and the second operation cycle refer to any two adjacent operation cycles.

FIG. 4 is a schematic diagram of another satellite signal processing apparatus according to an example embodiment. As shown in FIG. 4, the satellite signal processing apparatus includes a digital frontend circuit 401, a buffer 402, and a plurality of baseband signal processing channels 403. The plurality of baseband signal processing channels are identical and share a same operation principle and implementation technical effects. For illustrative purposes, one baseband signal processing channel will be described.

The digital frontend circuit 401 processes a radio frequency signal received from an antenna to obtain a baseband signal. The buffer 402 buffers the baseband signal obtained from the digital frontend circuit 401. Based on the baseband signal obtained from the buffer 402, the baseband signal processing channel 403 performs a plurality of work tasks assigned by an external device in the time-division manner in the first operation cycle. In some embodiments, the work task includes a capturing task or a tracking task.

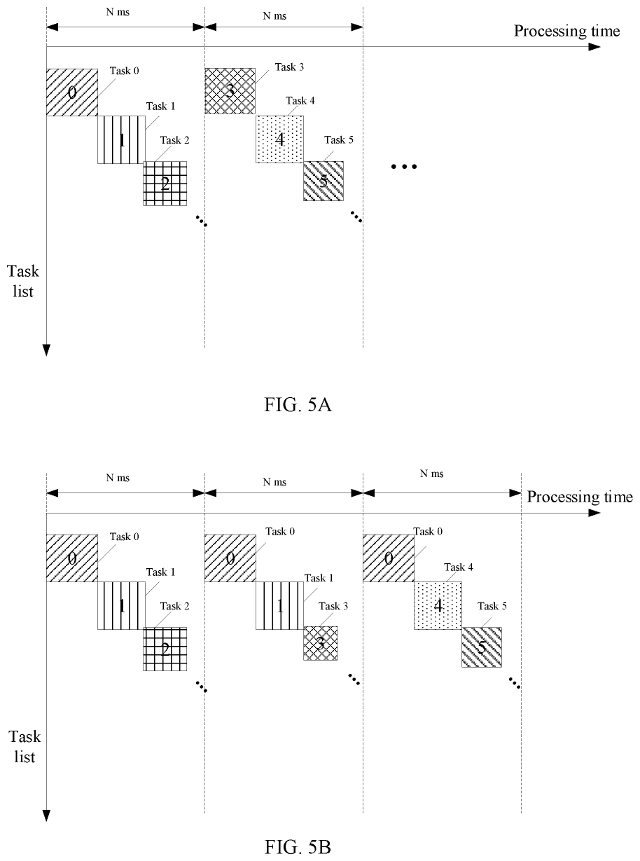

For example, the external device may assign the plurality of work tasks to the baseband signal processing channel. It is assumed that each operation cycle is N ms long, and the plurality of work tasks assigned to the first operation cycle include task 0, task 1, and task 2. The baseband signal processing channel performs the plurality of work tasks assigned by the external device in the time-division manner. That is, in the first operation cycle, the baseband signal processing channel sequentially performs task 0, task 1, and task 2. It is assumed that the plurality of work tasks assigned in the second operation cycle includes task 3, task 4, and task 5, and the baseband signal processing channel performs the plurality of work tasks assigned by the external device in the time-division manner. That is, in the second operation cycle, the baseband signal processing channel sequentially performs task 3, task 4, and task 5. As shown in FIG. 5A, a time period taken for performing a work task is determined based on an amount of baseband signal data to be obtained for performing the work task. Thus, the time periods for performing different work tasks may be the same or different and will not be limited by the present disclosure.

In some embodiments, the satellite signal processing apparatus may include the previously described pseudo-code broadcast circuit and may possess all the technical features in the foregoing embodiments.

In some embodiments, the external device may assign at one time the plurality of work tasks to the baseband signal processing channel. The baseband signal processing channel may process the plurality of work tasks in the time-division manner in one operation cycle to improve the utilization of the hardware resources and the task processing efficiency.

In some embodiments, when the baseband signal processing channel performs one of the plurality of work tasks that needs the amount of the baseband signal data more than the amount of the baseband signal data that can be obtained from the buffer in the first operation cycle, the baseband signal processing channel may process the amount of the baseband signal data obtained from the buffer and may then place the work task on hold. As shown in FIG. 5B, it is assumed that each operation cycle is N ms long, the amount of the baseband signal data needed for performing task 0 takes three operation cycles to obtain, and the amount of the baseband signal data needed for performing task 1 takes two operation cycles to obtain. Thus, in the first operation cycle, after the amount of the baseband signal data obtained from the buffer for performing task 0 is processed, task 0 is put on hold, and task 1 is performed. After the amount of the baseband signal data obtained from the buffer for performing task 1 is processed, task 1 is put on hold, and task 2 is performed. This prevents a certain task from holding on to the hardware resource of the baseband signal processing channel while waiting for obtaining more baseband signal data. Thus, the utilization of the hardware resources and the task processing efficiency may be improved.

In some embodiments, in the second operation cycle, the baseband signal processing channel continues to perform the work tasks that are put on hold based on additional baseband signal data obtained from the buffer. For example, as shown in FIG. 5B, upon entering the second operation cycle, the baseband signal processing channel continues to perform task 0 that is put on hold based on the baseband signal data obtained from the buffer in the second operation cycle. After the baseband signal data obtained from the buffer is processed, task 0 is again put on hold. The baseband signal processing channel continues to perform task 1 that is put on hold. After the baseband signal data for task 1 is processed, the baseband signal processing channel continues to perform task 3. In the subsequent operation cycle, the baseband signal processing channel continues to perform task 0 that is put on hold based on the baseband signal data obtained from the buffer in the current operation cycle. After the baseband signal data obtained from the buffer for task 0 is processed, the baseband signal processing channel continues to perform task 4. After the baseband signal data for task 4 is processed, the baseband signal processing channel continues to perform task 5. In some embodiments, in the second operation cycle, the baseband signal processing channel may process the on-hold work task before other work tasks (as shown in FIG. 5B) or may process other work tasks before the on-hold work task, which is not limited by the present disclosure.

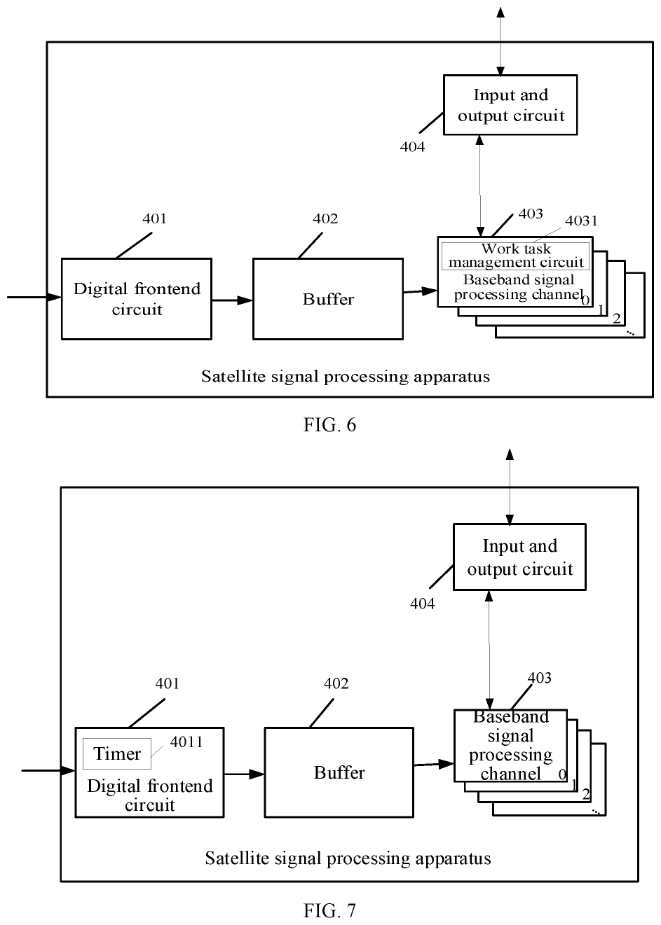

In some embodiments, as shown in FIG. 6, the satellite signal processing apparatus further includes an input and output circuit 404. The input and output circuit 404 may be the communication connection device between the external device and the baseband signal processing channel, and may be configured to obtain the configuration information of the plurality of work tasks from the external device in the first operation cycle and to send the configuration information of the plurality of work tasks to the baseband signal processing channel. Based on the configuration information of the plurality of work tasks and the baseband signals obtained from the buffer, the baseband signal processing channel 403 performs the plurality of work tasks assigned by the external device in the time-division manner in the first operation cycle. The configuration information of the plurality of work tasks includes one or more of a pseudo-code stepping, a carrier stepping, an initial pseudo-code phase, an initial carrier phase, a number of searched code phases, a number of non-coherent integrations, a non-coherent time, a satellite identifier, a GNSS system identifier, a work task type, a sampling frequency of a digital frontend circuit, and an antenna identifier. Table 1 includes the description of the configuration information.

TABLE 1

| Configuration information | Description |
|---|---|
| Antenna identifier | Identifies one antenna in a dual antenna |
| | system |
| DFE sampling frequency | Identifies selection of signals with different |
| | sampling frequencies for DFE |
| GNSS system identifier | Identifies selection of a GNSS system |
| | (GPS, BeiDou, etc.) |
| Satellite identifier | Identifies selection of a satellite |
| Coherent integration time | Coherent integration time (X) in ms |
| Number of non-coherent | Number (Y) of non-coherent integrations |
| integrations | |
| Number of searched code | Number (Z) of searched code phases |
| phases | |
| Initial carrier phase | Initial carrier phase |
| Initial pseudo-code phase | Initial pseudo-code phase |
| Carrier stepping | Carrier stepping |
| Pseudo-code stepping | Pseudo-code stepping |

In some embodiments, in the first operation cycle, the input and output circuit also writes the work task result outputted from the baseband signal processing channel to the external device as previously described.

In some embodiments, as shown in FIG. 6, the baseband signal processing channel further includes a work task management circuit 4031. The input and output circuit 404 obtains the configuration information of the plurality of work tasks from the external device in the first operation cycle and sends the configuration information of the plurality of work tasks to the work task management circuit 4031. The baseband signal processing channel 403 performs the plurality of work tasks assigned by the external device in the time-division manner in the first operation cycle based on the configuration information of the plurality of work tasks in the work task management circuit 4031 and the baseband signals obtained from the buffer.

For example, the external device assigns the plurality of work tasks to the baseband signal processing channel. In some embodiments, the satellite signal processing apparatus may include a control register. The control register may be connected to the external device through an APB4 protocol. The external device may write to the control register to assign a number of the work tasks to the satellite signal processing apparatus. The input and output circuit 404 obtains the configuration information of the plurality of work tasks from the external device in the first operation cycle and sends the configuration information of the plurality of work tasks to the work task management circuit 4031. The baseband signal processing channel may sequentially perform the plurality of work tasks in the time-division manner based on the configuration information of the plurality of work tasks in the work task management circuit 4031.

The work task management circuit 4031 of the baseband signal processing channel may include T groups of task management registers, where T is an integer equal to or larger than one. The baseband signal processing channel may perform at maximum T work tasks. The external device may assign at maximum T work tasks to the baseband signal processing channel. Each work task corresponds to a task management register. Each task management register may save the configuration information of one work task.

In some embodiments, in the first operation cycle, if the baseband signal processing channel has already performed the work task, the baseband signal processing channel may output the work task result corresponding to the work task and may flag the task management register corresponding to the work task. After the first operation cycle ends, the external device may query the task management register to determine whether the work task has been performed. In addition, the external device may determine which of the plurality of work tasks is put on hold through querying the task management circuit.

In the examples shown in FIGS. 4-6, a duration of the operation cycle can be configurable. In some embodiments, as shown in FIG. 7, the digital frontend circuit includes a timer 4011. The duration of the operation cycle is configured by the timer 4011. For example, the digital frontend circuit may include the timer. Upon power-up of the satellite signal processing apparatus, the timer starts counting. After a counter of the timer reaches a preset maximum number, the timer is interrupted, and the counter resets and starts counting again. That is, a timer interrupt indicates a beginning or an ending of the operation cycle. The timer may be set to configure the duration of the operation cycle. Further, the satellite signal processing apparatus may include the control register. The external device may set the timer by writing data to the control register for the purpose of configuring the operation cycle.

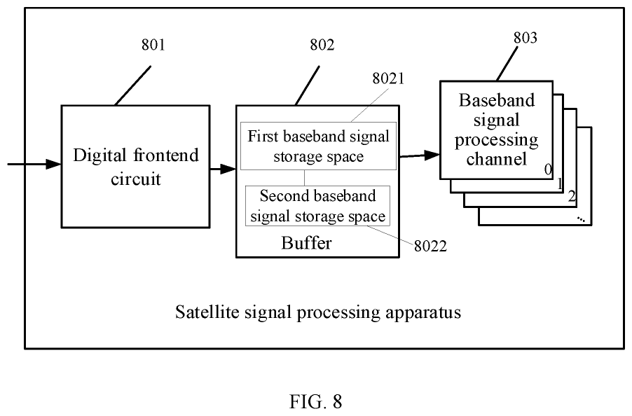

FIG. 8 is a schematic diagram of another satellite signal processing apparatus according to an example embodiment. As shown in FIG. 8, the satellite signal processing apparatus includes a digital frontend circuit 801, a buffer 802, and a plurality of baseband signal processing channels 803. The buffer 802 includes a first baseband signal storage space 8021 and a second baseband signal storage space 8022.

The digital frontend circuit processes the radio frequency signal received from the antenna to obtain the baseband signal. The buffer stores the baseband signal obtained from the digital frontend circuit. In the first operation cycle, the baseband signal processing channel performs the work task based on the baseband signal obtained from the first baseband signal storage space 8021 of the buffer 802. In the second operation cycle, the baseband signal processing channel performs the work task based on the baseband signal obtained from the second baseband signa storage space 8022 of the buffer 802.

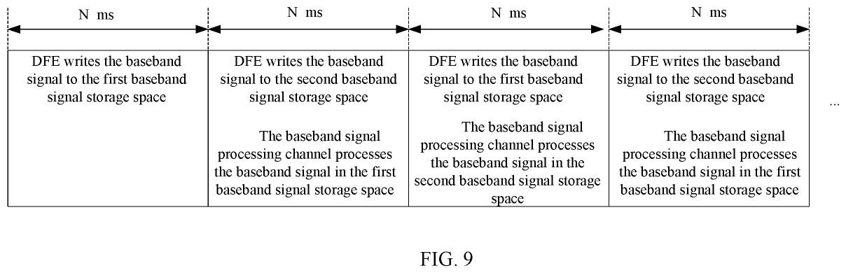

The digital frontend circuit uses the ping-pong address policy to alternately write the baseband signals to the two baseband signal storage spaces. As shown in FIG. 9, the baseband signal processing channel uses the ping-pong address policy to alternately process the baseband signals stored in the two baseband signal storage spaces. In the duration N ms of the first operation cycle, the digital frontend circuit writes the data to the first baseband signal storage space of the buffer. In the duration N ms of the second operation cycle, the baseband signal; processing channel obtains the baseband signal from the first baseband signal storage space of the buffer and performs the work task based on the baseband signal. At the same time, the digital frontend circuit writes the baseband signal to the second baseband signal storage space of the buffer. In the duration N ms of the third operation cycle, the baseband signal processing channel obtains the baseband signal from the second baseband signal storage space of the buffer. At the same time, the digital frontend circuit writes the baseband signal to the first baseband signal storage space of the buffer.

The satellite signal processing apparatus may include the pseudo-code broadcast circuit described above and may possess all the relevant technical features of the pseudo-code broadcast circuit. In addition, the baseband signal processing channel of the satellite signal processing apparatus may also perform the plurality of work tasks assigned by the external device in the time-division manner and may possess all the technical features as previously described.

In some embodiments, the two baseband signal storage spaces are configured in the buffer, and the baseband signal processing channel uses the ping-pong address policy to alternately obtain the baseband signals from the two baseband signal storage spaces. As such, the efficiency that the baseband signal processing channel obtains the baseband signals, the processing efficiency of the baseband signal processing channel, and the utilization of the hardware resources are all improved.

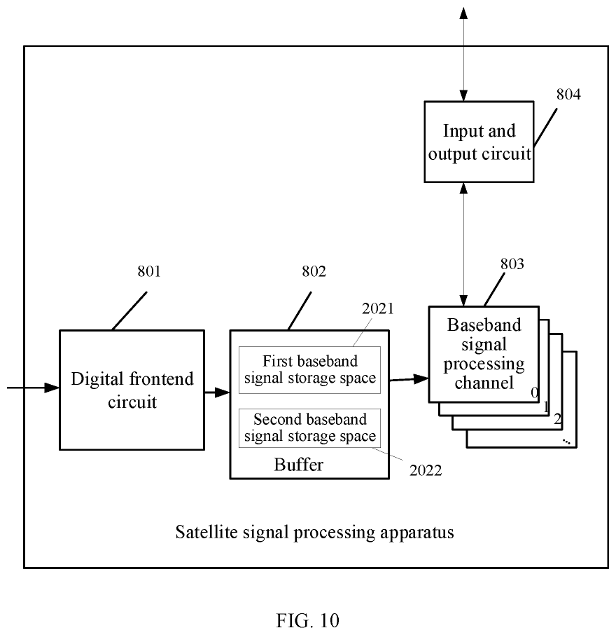

In some embodiments, the satellite signal processing apparatus further includes an input and output circuit 804, as shown in FIG. 10. The input and output circuit 804 obtains the configuration information of the plurality of work tasks from the external device in the first operation cycle and the second operation cycle and sends the configuration information of the plurality of work tasks to the baseband signal processing channel.

In the first operation cycle, the baseband signal processing channel performs the work task based on the baseband signal obtained from the first baseband signal storage space of the buffer and the configuration information of the work task that the input and output circuit obtains in the first operation cycle. In the second operation cycle, the baseband signal processing channel performs the work task based on the baseband signal obtained from the second baseband signal storage space of the buffer and the configuration information of the work task that the input and output circuit obtains in the second operation cycle.

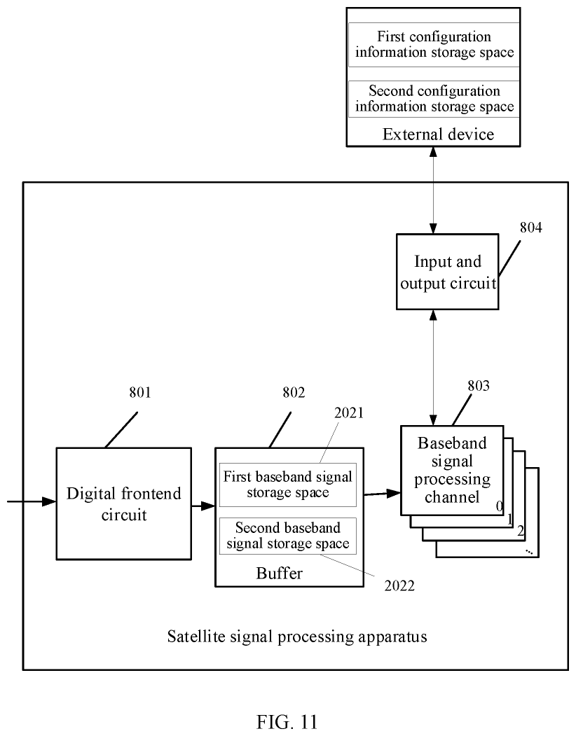

In some embodiments, two configuration information storage spaces are set in the external device, as shown in FIG. 11. The two configuration information storage spaces include a first configuration information storage space and a second configuration information storage space. The input and output circuit obtains the configuration information of the work task from the first configuration information storage space in the first operation cycle and from the second configuration information storage space in the second operation cycle, and sends the configuration information of the work task to the baseband signal processing channel. The baseband signal processing channel uses the ping-pong address policy to alternately obtain the configuration information of the work task from the two configuration information storage spaces.

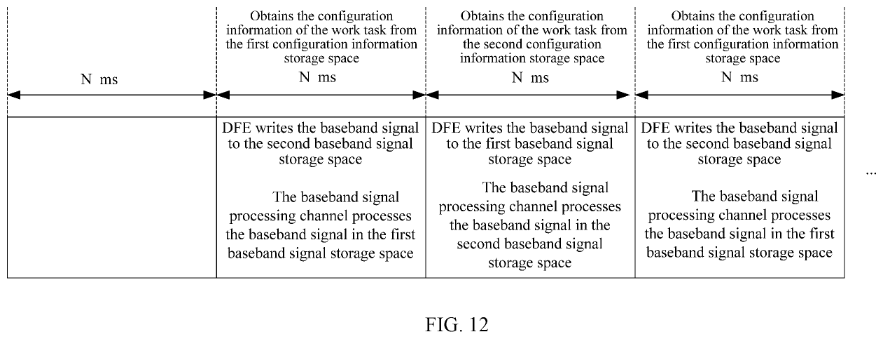

As shown in FIG. 12, for example, in the first operation cycle, the input and output circuit obtains the configuration information of the work task from the first configuration information storage space of the external device and sends the configuration information of the work task to the baseband signal processing channel. The baseband signal processing channel performs the work task based on the configuration information of the work task and the baseband signal obtained from the first baseband signal storage space of the buffer. In the second operation cycle, the input and output circuit obtains the configuration information of the work task from the second configuration information storage space of the external device and sends the configuration information of the work task to the baseband signal processing channel. The baseband signal processing channel performs the work task based on the configuration information of the work task and the baseband signal obtained from the second baseband signal storage space of the buffer.

In some embodiments, the two configuration information storage spaces are set in the external device, and the input and output circuit uses the ping-pong address policy to alternately obtain the configuration information of the work task from the two configuration information storage spaces. Thus, the efficiency of obtaining the configuration information of the work task is improved.

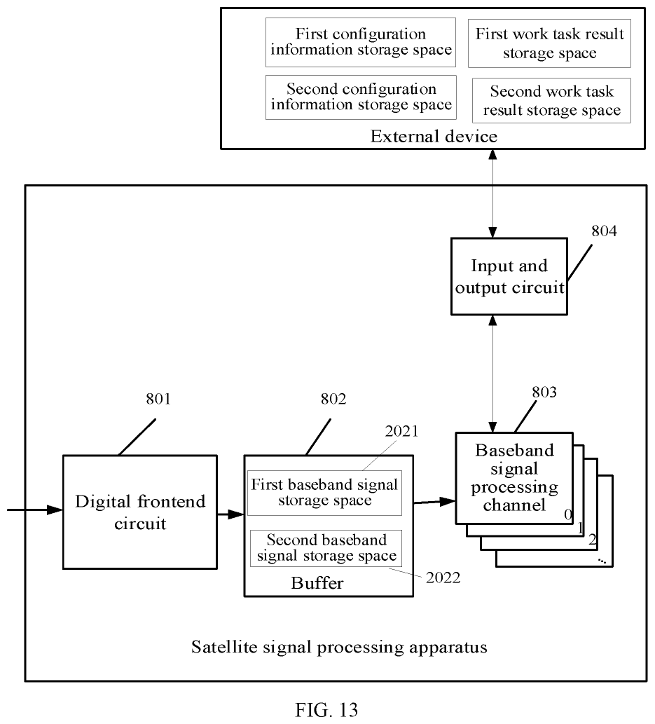

In some embodiments, two work task result storage spaces are set in the external device, as shown in FIG. 13. The two work task result storage spaces include a first work task result storage space and a second work task result storage space. In the first operation cycle, the input and output circuit writes the work task result outputted from the baseband signal processing channel to the first work task result storage space of the external device. In the second operation cycle, the input and output circuit writes the work task result outputted from the baseband signal processing channel to the second work task result storage space of the external device.

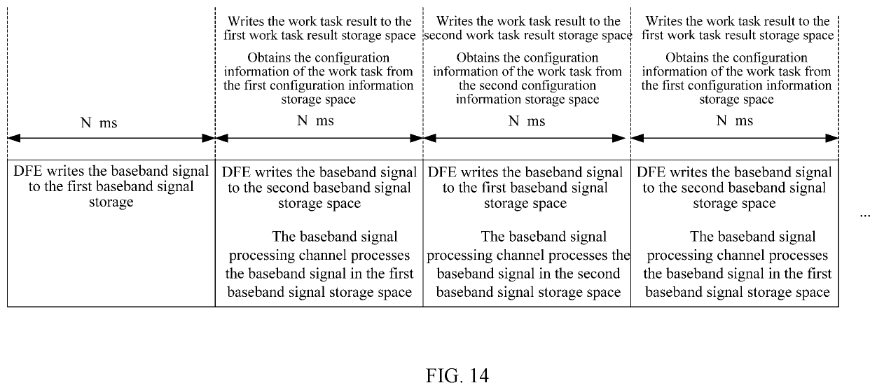

As shown in FIG. 14, the input and output circuit uses the ping-pong address policy to alternately write the work task result to the two work task result storage spaces. In the first operation cycle, the digital frontend circuit writes the baseband signal to the first baseband signal storage space. In the second operation cycle, the baseband signal processing channel processes the baseband signal stored in the first baseband signal storage space, writes the processing result to the first work task result storage space, and obtains the configuration information of the work task from the first configuration information storage space. At the same time, the digital frontend circuit writes the baseband signal to the second baseband signal storage space. In the third operation cycle, the baseband signal processing channel processes the baseband signal stored in the second baseband signal storage space, writes the processing result to the second work task result storage space, and obtains the configuration information of the work task from the second configuration information storage space. At the same time, the digital frontend circuit writes the baseband signal to the first baseband signal storage space. In the fourth operation cycle, the baseband signal processing channel processes the baseband signal stored in the first baseband signal storage space, writes the processing result to the first work task result storage space, and obtains the configuration information of the work task from the first configuration information storage space. At the same time, the digital frontend circuit writes the baseband signal to the second baseband signal storage space.

In some embodiments, the two work task result storage spaces are set in the external device, and the input and output circuit uses the ping-pong address policy to alternately write the processing result to the two work task result storage spaces. Thus, the efficiency of writing the work task result is improved.

Another embodiment is provided based on the embodiments shown in FIG. 8, FIG. 10, or FIG. 11. In the first operation cycle, the input and output circuit writes the work task result outputted from the baseband signal processing channel to a work task result storage space of the external device. In the second operation cycle, the input and output circuit writes the work task result outputted from the baseband signal processing channel to the work task result storage space of the external device.

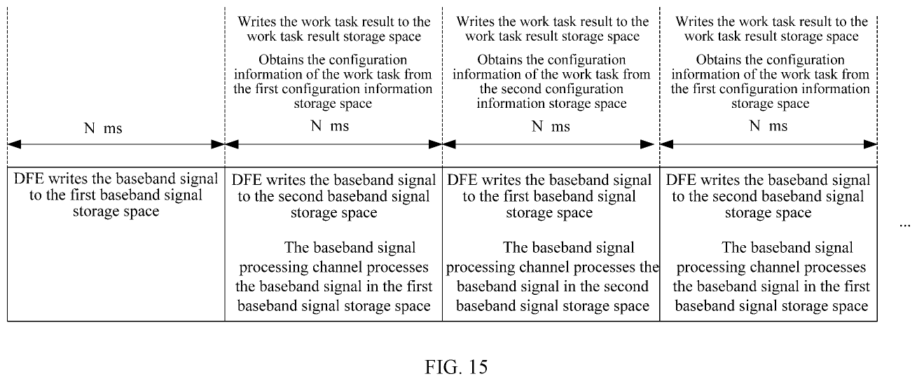

As shown in FIG. 15, in the first operation cycle, the digital frontend circuit writes the baseband signal to the first baseband signal storage space. In the second operation cycle, the baseband signal processing channel processes the baseband signal stored in the first baseband signal storage space, writes the processing result to the work task result storage space, and obtains the configuration information of the work task from the first configuration information storage space. At the same time, the digital frontend circuit writes the baseband signal to the second baseband signal storage space. In the third operation cycle, the baseband signal processing channel processes the baseband signal stored in the second baseband signal storage space, writes the processing result to the work task result storage space, and obtains the configuration information of the work task from the second configuration information storage space. At the same time, the digital frontend circuit writes the baseband signal to the first baseband signal storage space. In the fourth operation cycle, the baseband signal processing channel processes the baseband signal stored in the first baseband signal storage space, writes the processing result to the work task result storage space, and obtains the configuration information of the work task from the first configuration information storage space. At the same time, the digital frontend circuit writes the baseband signal to the second baseband signal storage space.

Another embodiment is provided based on the embodiments shown in FIGS. 8-14. In the second operation cycle, when the baseband signal processing channel fails to receive the configuration information of the work task sent by the input and output circuit within a preset time, the baseband signal processing channel performs the work task based on the baseband signal obtained from the second storage space of the buffer and the configuration information of the work task that the input and output circuit obtains in the first operation cycle.

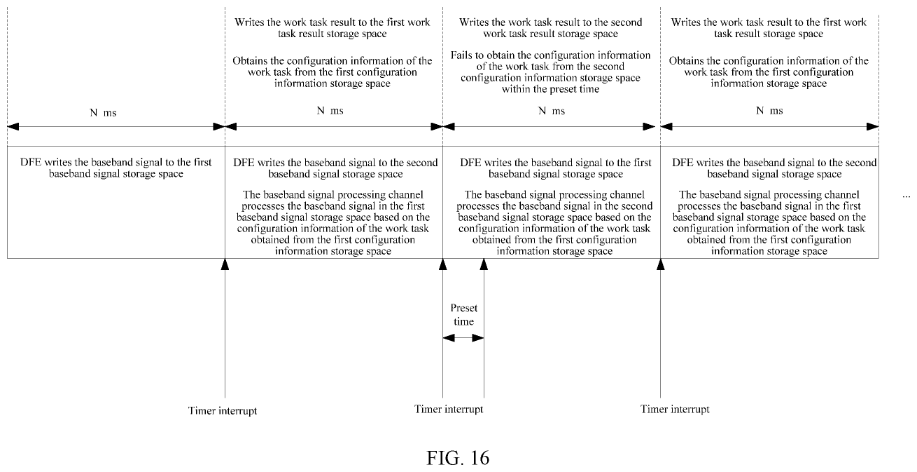

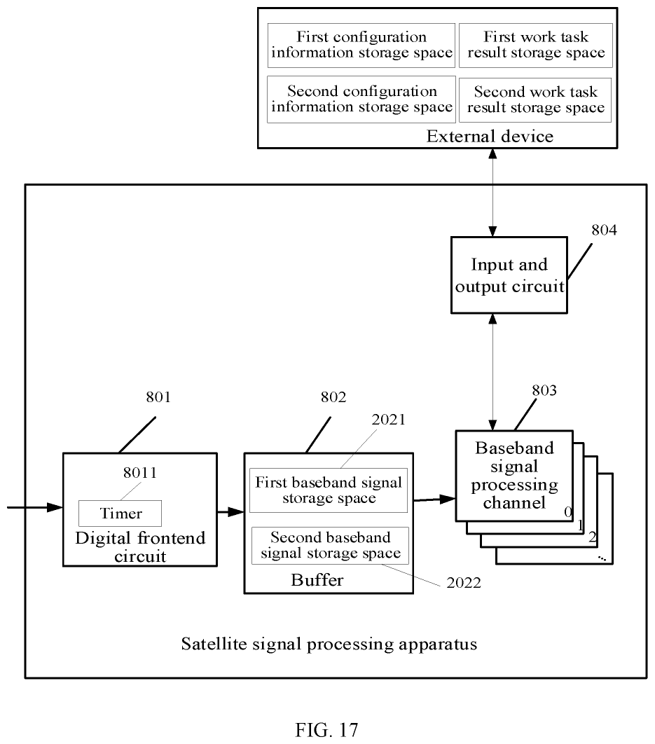

For example, as shown in FIG. 16, when the timer interrupt occurs, i.e., upon entering the second operation cycle, the counter of the timer resets and starts counting again. If the baseband signal processing channel does not receive the configuration information of the work task sent by the input and output circuit by the time the counter reaches the preset time configured by the external device, that is, the baseband signal processing channel does not receive the configuration information of the work task sent by the input and output circuit within the preset time, the baseband signal processing channel may perform the work task based on the configuration information that the baseband signal processing channel obtains in the first operation cycle.

In the embodiments shown in FIGS. 8-16, the durations of the first operation cycle and the second operation cycle are configurable. In some embodiments, as shown in FIG. 17, the digital frontend circuit includes a timer 8011. The durations of the first operation cycle and the second operation cycle may be configured through the timer 8011 or may be configured by software. The previous description may be referenced to for details of configuring the durations of the operation cycles, and no details will be repeated herein.

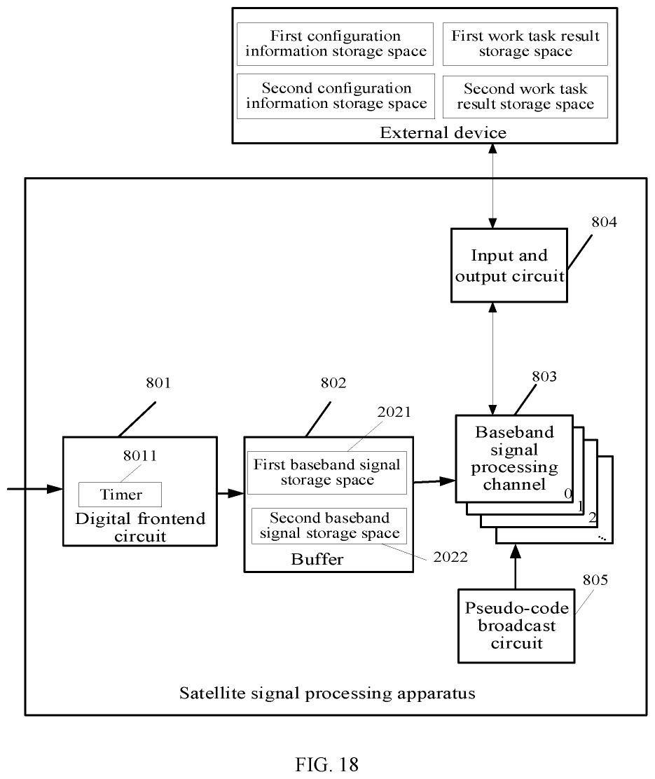

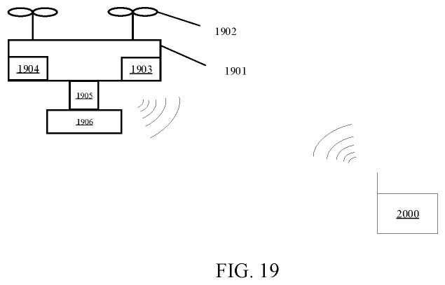

FIG. 18 is a schematic diagram of another satellite signal processing apparatus according to an example embodiment. As shown in FIG. 18, the satellite signal processing apparatus further includes a pseudo-code broadcast circuit 805. The pseudo-code broadcast circuit 805 is connected to each and every one of the plurality of baseband signal processing channels. The pseudo-code broadcast circuit 805 stores the pseudo-codes of the plurality of satellites. In the first operation cycle, the baseband signal processing channel 803 is configured to perform the work task based on the pseudo-code transmitted from the pseudo-code broadcast circuit and the baseband signal obtained from the first baseband signal storage space. In the second operation cycle, the baseband signal processing channel 803 is configured to perform the work task based on the pseudo-code transmitted from the pseudo-code broadcast circuit and the baseband signal obtained from the second baseband signal storage space. In some embodiments, performing the work task may include performing a plurality of work tasks in one operation cycle.

The present disclosure also provides an unmanned aerial vehicle. FIG. 19 is a schematic diagram of an unmanned aerial vehicle according to an example embodiment. As show in FIG. 19, the unmanned aerial vehicle includes a body 1910 (vehicle body), a power system 1920 mounted at the body 1910 for supplying flight power, and a satellite signal processing apparatus 1930, such as one of the above-described example satellite signal processing apparatuses.

In some embodiments, the unmanned aerial vehicle further includes a processor 1940 configured to process data outputted from the satellite signal processing apparatus to control the unmanned aerial vehicle. The power system 1920 includes one or more of a propeller, a motor, and an electronic speed control (ESC) system. An installation error detection device of a speedometer is configured to detect an installation error angle of an accelerator and to further correct actual output data of acceleration.

The unmanned aerial vehicle further includes a gimbal 1950 and an imaging device 1960. The imaging device 1960 is mounted at the body 1910 of the unmanned vehicle through the gimbal 1950. The imaging device 1960 is configured to capture photograph images or videos during flight of the unmanned aerial vehicle. The imaging device 1960 may include, but is not limited to, a multi-spectral imaging device, a hyperspectral imaging device, a visible light camera, or an infrared camera. The gimbal 1950 may be a multi-axis rotation and stabilization system. A gimbal motor may compensate a shooting angle of the imaging device 1960 by adjusting a rotation angle of a rotation shaft. Vibration of the imaging device 1960 may be prevented or reduced through an appropriate buffering mechanism. The unmanned aerial vehicle may receive control instructions, such as flight control instructions, gimbal control instructions, or control instructions for the imaging device 1960 of the unmanned aerial vehicle, from a control terminal 2000, and may perform actions corresponding to the control instructions.

A method consistent with the disclosure can be wholly or partially implemented by software or hardware associated with program instructions. The program instructions can cause a computer (e.g., a personal computer, a server, or a network device, etc.) or a processor to execute certain processes of the method embodiments. The software or program may be stored in a computer-readable medium. The storage medium may include a U-disk, a portable disk, a read-only memory (ROM), a random access memory (RAM), a magnetic disk, an optical disk, or other media that can store program instructions.

The foregoing descriptions are merely some implementation manners of the present disclosure, but the scope of the present disclosure is not limited thereto. Any change or replacement that can be conceived by a person skilled in the art based on the technical scope disclosed by the present application should be covered by the scope of the present disclosure. A true scope and spirit of the invention is indicated by the following claims.

What is claimed is:

1. A satellite signal processing apparatus comprising:
a digital frontend circuit configured to process a radio frequency signal received from an antenna to obtain a baseband signal;
a buffer configured to buffer the baseband signal obtained from the digital frontend circuit;
a pseudo-code broadcast circuit storing pseudo-codes of a plurality of satellites; and
a baseband signal processing channel coupled to the pseudo-code broadcast circuit, and configured to perform a work task based on a pseudo-code broadcasted by the pseudo-code broadcast circuit and the baseband signal obtained from the buffer.

2. The apparatus of claim 1, wherein:
the baseband signal processing channel is further configured to send a pseudo-code request to the pseudo-code broadcast circuit to request the pseudo-code; and
the pseudo-code broadcast circuit is configured to broadcast the pseudo-code indicated by the pseudo-code request to the baseband signal processing channel.

3. The apparatus of claim 2, wherein the baseband signal processing channel is configured to send the pseudo-code request to the pseudo-code broadcast circuit in response to the pseudo-code needed for performing the work task being different from a previous pseudo-code needed for performing a preceding work task.

4. The apparatus of claim 2, wherein the pseudo-code request includes at least a satellite identifier.

5. The apparatus of claim 1, wherein the baseband signal processing channel includes a local pseudo-code storage circuit configured to receive and save the pseudo-codes broadcasted by pseudo-code broadcast circuit.

6. The apparatus of claim 1, further comprising:
an input and output circuit configured to obtain configuration information of the work task from an external device and send the configuration information to the baseband signal processing channel;
the baseband signal processing channel is configured to perform the work task based on the configuration information, the pseudo-code, and the baseband signal.

7. The apparatus of claim 1, wherein the work task includes a capturing task or a tracking task.

8. The device of claim 1, wherein the work task is one of a plurality of work tasks assigned by an external device and to be performed by the baseband signal processing channel in a time-division manner in an operation cycle based on the pseudo-code and the baseband signal.

9. The apparatus of claim 8, wherein the baseband signal processing channel is further configured to, in response to an amount of needed baseband signal data for performing one of the plurality of work tasks being greater than an amount of received baseband signal data obtained from the buffer in the operation cycle, put the one of the plurality of work tasks on hold after the baseband signal obtained from the buffer is processed.

10. The apparatus of claim 9, wherein:
the operation cycle is a first operation cycle; and
the baseband signal processing channel is further configured to continue to perform the one of the plurality of work tasks based on the baseband signal obtained from the buffer in a second operation cycle immediately following the first operation cycle.

11. The apparatus of claim 8, further comprising:
an input and output circuit configured to, in the operation cycle, obtain configuration information of the plurality of work tasks from the external device and send the configuration information to the baseband signal processing channel;
the baseband signal processing channel is configured to perform the plurality of work tasks in the time-division manner based on the configuration information, the pseudo-code, and the baseband signal.

12. The apparatus of claim 11, wherein:
the baseband signal processing channel includes a work task management circuit;
the input and output circuit is further configured to send the configuration information to the work task management circuit; and
the baseband signal processing channel is configured to perform the plurality of work tasks in the time-division manner in the time-division manner based on the configuration information in the work task management circuit, the pseudo-code, and the baseband signal.

13. The apparatus of claim 11, wherein:
the baseband signal processing channel is further configured to, in the operation cycle, output a work task result corresponding to one of the plurality of work tasks that is completed in the operation cycle; and
the input and output circuit is further configured to send the work task result to the external device in the operation cycle.

14. The apparatus of claim 11, wherein the configuration information includes one or more of a pseudo-code stepping, a carrier stepping, an initial pseudo-code phase, an initial carrier phase, a number of searched code phases, a number of non-coherent integrations, a non-coherent time, a satellite identifier, a GNSS system identifier, a work task type, a sampling frequency of the digital frontend circuit, and an antenna identifier.

15. The apparatus of claim 8, wherein a duration of the operation cycle is configurable.

16. The apparatus of claim 15, wherein the digital frontend circuit includes a timer configured to configure the duration of the operation cycle.

17. The apparatus of claim 8, wherein the work task includes a capturing task or a tracking task.

18. The apparatus of claim 8, wherein:
the operation cycle is a first operation cycle and the baseband signal is a first baseband signal obtained from a first baseband signal storage space of the buffer; and
the baseband signal processing channel is further configured to perform the work task based on a second baseband signal obtained from a second baseband storage space of the buffer in a second operation cycle immediately following the first operation cycle.

19. The apparatus of claim 1, wherein the baseband signal processing circuit is one of a plurality of baseband signal processing circuits of the satellite signal processing apparatus.

20. The apparatus of claim 19, wherein the pseudo-code broadcast circuit is coupled to each the plurality of baseband signal processing channels.
